(19) United States
(12) Patent Application Publication
(10) Pub. No.: US 2005/0147859 A1
(43) Pub. Date: Jul. 7, 2005

(54) Mixture comprising phosphonic acid containing vinyl, polymer electrolyte membranes comprising polyvinylphoshphonic acid and the use thereof in fuel cells

(76) Inventors: Joachim Kiefer, Mainz (DE); Oemer Uensal, Mainz (DE); Gunter Christ, Wallrabenstein (DE)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/506,646

(22) PCT Filed: Mar. 4, 2003
(86) PCT No.: PCT/EP03/02398

(30) Foreign Application Priority Data
Mar. 6, 2002 (DE) 102 13 540.1

(51) Int. Cl. H01M 8/10; C08J 5/22

(52) U.S. Cl. 429/33; 521/27

(57) ABSTRACT

Mixtures containing vinyl-containing phosphonic acid, polymer electrolyte membranes comprising polyvinylphosphonic acid and their use in fuel cells. The present invention relates to a proton-conducting polymer membrane based on polyvinylphosphonic acid obtainable by a process comprising the steps A) Mixing a polymer with vinyl-containing phosphonic acid, B) Forming a two-dimensional structure using the mixture according to step A) on a carrier, C) Polymerisation of the vinyl-containing phosphonic acid present in the two-dimensional structure according to step B). A membrane according to the invention may on account of its outstanding chemical and thermal properties be used in a wide range of applications and is particularly suitable as a polymer-electrolyte membrane (PEM) in so-called PEM fuel cells.

Mixtures comprising vinyl-containing phosphonic acid, polymer electrolyte membranes comprising polyvinylphosphonic acid and their use in fuel cells.

The present invention relates to a mixture comprising vinylphosphonic acid monomers and a proton-conducting polymer electrolyte membrane based on polyvinylphosphonic acid, which on account of its outstanding chemical and thermal properties can be used in many applications and is suitable in particular as a polymer-electrolyte membrane (PEM) in so-called PEM fuel cells.

A fuel cell normally contains an electrolyte and two electrodes separated by the electrolyte. In a fuel cell one of the two electrodes is a fuel such as hydrogen gas or a methanol-water mixture, and an oxidising agent such as gaseous oxygen or air is fed to the other electrode and chemical energy from the fuel oxidation is thereby converted directly into electrical energy. Protons and electrons are formed in the oxidation reaction.

The electrolyte is permeable to hydrogen ions, i.e. protons, but is not permeable to reactive fuels such as the hydrogen gas or methanol and gaseous oxygen.

A fuel cell generally comprises a plurality of individual cells, so-called MEEs (Membrane-Electrode Unit), which in each case contain an electrolyte and two electrodes separated by the electrolyte.

Solids such as polymer electrolyte membranes or liquids such as phosphoric acid are used as electrolyte for the fuel cell. Recently polymer electrolyte membranes have attracted attention as electrolyte for fuel cells. In principle two categories of polymer membranes may be distinguished.

Among the first category are cation exchanger membranes consisting of a polymer framework that contains covalently bonded acid groups, preferably sulfonic acid groups. The sulfonic acid group is converted into an anion with the release of a hydrogen ion and therefore conducts protons. The mobility of the proton and thus the proton conductivity is in this connection directly related to the water content. Due to the extremely good miscibility of methanol and water such cation exchanger membranes have a high methanol permeability and are therefore unsuitable for applications in a direct methanol fuel cell. If the membrane dries out, for example as a result of high temperatures, the conductivity of the membrane and consequently the performance of the fuel cell drops dramatically. The operating temperature of fuel cells containing such cation exchanger membranes is thus restricted to the boiling point of water. The wetting of the fuel cell is thus a major technical challenge for the use of polymer electrolyte membrane fuel cells (PEMFC), in which conventional, sulfonated membranes such as e.g. Nafion® are employed.

Accordingly, perfluorosulfonic acid polymers for example are used as materials for polymer electrolyte membranes. The perfluorosulfonic acid polymer (such as e.g. Nafion®) generally comprises a perfluorinated hydrocarbon framework, such as a copolymer of tetrafluoroethylene and trifluorovinyl, and a side chain with a sulfonic acid group bonded thereto, such as a side chain with a sulfonic acid group bonded to a perfluoroalkylene group.

Cation exchanger membranes preferably involve organic polymers with covalently bonded acid groups, in particular sulfonic acid. Processes for the sulfonation of polymers are described in F. Kucera et al., Polymer Engineering and Science 1988, Vol. 38, No. 5, 783-792.

The most important types of cation exchange membranes that have achieved commercial importance for use in fuel cells are listed hereinafter. The most important example is the perfluorosulfonic acid polymer Nafion® (U.S. Pat. No. 3,692,569). This polymer may be brought into solution as described in U.S. Pat. No. 4,453,991 and then used as ionomer. Cation exchanger membranes are also obtained by filling a porous carrier material with such an ionomer. Expanded Teflon is preferably used in this connection as carrier material (U.S. Pat. No. 5,635,041). A further perfluorinated cation exchanger membrane may be produced as described in U.S. Pat. No. 5,422,411 by copolymerisation of trifluorostyrene and sulfonyl-modified trifluorostyrene. Composite membranes consisting of a porous carrier material, in particular expanded Teflon, filled with ionomers consisting of such sulfonyl-modified trifluorostyrene copolymers are described in U.S. Pat. No. 5,834,523.

U.S. Pat. No. 6,110,616 describes copolymers of butadiene and styrene and their subsequent sulfonation for the production of cation exchanger membranes for fuel cells.

A further class of partially fluorinated cation exchanger membranes may be produced by irradiation grafting and subsequent sulfonation. In this connection, as described in EP 667983 or DE 19844645, a grafting reaction, preferably with styrene, is carried out on a previously irradiated polymer film. The sulfonation of the side chains then takes place in a subsequent sulfonation reaction. A crosslinking may also be carried out at the same time as the grafting and in this way the mechanical properties can be altered.

In addition to the above membranes a further class of non-fluorinated membranes has been developed by sulfonation of high temperature-stable thermoplastic materials. Thus, membranes of sulfonated polyether ketones (DE 4219077, EP 96/01177), sulfonated polysulfone (J. Membr. Sci. 83 (1993) p. 211) or sulfonated polyphenylene sulfide (DE 19527435) are known.

Ionomers produced from sulfonated polyether ketones are described in WO 00/15691.

In addition acid-base blend membranes are also known, which are produced as described in DE 19817374 or WO 01/18894 by mixing sulfonated polymers and basic polymers.

In order to improve the membrane properties still further a cation exchanger membrane known from the prior art may be mixed with a high temperature-stable polymer. The production and properties of cation exchanger membranes consisting of blends of sulfonated PEK and a) polysulfones (DE 4422158), b) aromatic polyamides (DE 42445264) or c) polybenzimidazole (DE 19851498) have been described.

A disadvantage of all these cation exchanger membranes is the fact that the membrane has to be wetted, the operating temperature is restricted to 100° C., and the membranes have a high methanol permeability. The reason for these disadvantages is the conductivity mechanism of the membrane, in which the transport of the protons is coupled to the transport of the water molecule. This is termed “vehicle mechanism” (K.-D. Kreuer, Chem. Mater. 1996, 8, 610-641).

As a second category there has been developed polymer electrolyte membranes with complexes of basic polymers and strong acids. Thus, WO 096/13872 and the corresponding U.S. Pat. No. 5,525,436 describe a process for the production of a proton-conducting polymer electrolyte membrane, in which a basic polymer such as polybenzimidazole is treated with a strong acid such as phosphoric acid, sulfuric acid, etc.

The doping of a polybenzimidazole in phosphoric acid is described in J. Electrochem. Soc., Vol. 142, No. 7, 1995, pp. L121-L123.

In the case of the basic polymer membranes known in the prior art the mineral acid (generally concentrated phosphoric acid) used to achieve the necessary proton conductivity is employed either after the shaping stage, or alternatively the basic polymer membrane is produced directly from polyphosphoric acid, as in German patent application No. 10117686.4, No. 10144815.5 and No. 10117687.2. The polymer serves in this case as a carrier for the electrolyte consisting of highly concentrated phosphoric acid or polyphosphoric acid. The polymer membrane fulfils further essential functions, and in particular must have a high mechanical stability and must serve as a separator for the two fuels mentioned in the introduction.

The main advantages of such a membrane doped with phosphoric acid or polyphosphoric acid is the fact that a fuel cell in which such a polymer electrolyte membrane is employed can be operated at temperatures above 100° C. without an otherwise necessary wetting of the fuels. This is based on the property of phosphoric acid of being able to transport protons without additional water by means of the so-called Grotthus mechanism (K.-D. Kreuer, Chem. Mater. 1996, 8, 610-641).

The fuel cell system has further advantages due to the possibility of being able to operate at temperatures above 100° C. On the one hand the sensitivity of the Pt catalyst to gaseous impurities, in particular CO, is greatly reduced. CO is formed as a by-product in the reforming of the hydrogen-rich gas from carbon-containing compounds, such as for example natural gas, methanol or petrol, or also as an intermediate product in the direct oxidation of methanol. Typically the CO content of the fuel at temperatures <100° C. must be less than 100 ppm. At temperatures in the range from 150° to 200° C. however levels of 1000 ppm CO or more may also be tolerated (N. J. Bjerrum et al. Journal of Applied Electrochemistry, 2001, 31, 773-779). This leads to significant simplifications in the upstream-connected reforming process and thus to cost savings of the overall fuel cell system.

A major advantage of fuel cells is the fact that in the electrochemical reaction the energy of the fuel is directly converted into electrical energy and heat. Water is formed as a reaction product at the cathode. Heat is thus formed as a by-product in the electrochemical reaction. For applications in which only current is used to drive electric motors, such as for example for automobile applications, or as a versatile replacement for battery systems, the heat must be dissipated in order to prevent an overheating of the system. Additional, energy-consuming equipment are then necessary for the cooling, which further reduce the overall electrical efficiency of the fuel cell. For stationary uses such as the centralised or decentralised generation of current and heat the heat can be efficiency utilised by existing technologies, such as e.g. heat exchangers. In order to improve the efficiency high temperatures are in this case desirable. If the operating temperature is above 100° C. and the temperature difference between the ambient temperature and the operating temperature is large, then it is possible to cool the fuel cell system more efficiently or to use small cooling surfaces and dispense with additional equipment, compared to fuel cells that have to be operated below 100° C. on account of the need to wet the membrane.

Apart from these advantages such a fuel cell system has a serious disadvantage however. Thus, phosphoric acid or polyphosphoric acid exist as electrolyte, which due to ionic interactions is not permanently bonded to the basic polymer and can be washed out by water. As described above, in the electrochemical reaction water is formed at the cathode. If the operating temperature is above 100° C. the water is largely removed as steam via the gas diffusion electrode and the acid loss is very low. If the operating temperature falls below 100° C. however, for example when starting up and shutting down the cell or under idling operation, when a high current yield is required, the water that is formed condenses and can lead to an increased washing out of the electrolyte, highly concentrated phosphoric acid or polyphosphoric acid. In the case of the aforedescribed operating mode of the fuel cell this can lead to a constant loss of conductivity and cell output, which in turn can reduce the service life of the fuel cell.

In addition the known membranes doped with phosphoric acid cannot be used in the so-called direct methanol fuel cell (DMFC). Such cells are however of particular interest since a methanol-water mixture is used as fuel. If a known membrane based on phosphoric acid is used, the fuel cell fails after an extremely short time.

The object of the present invention is accordingly to provide a novel polymer electrolyte membrane in which a washing-out of the electrolyte is prevented. In particular the operating temperature should be able to be broadened from <0° C. up to 200° C. and the system should not need to be wetted. A fuel cell containing a polymer electrolyte membrane according to the invention should be suitable for pure hydrogen as well as for numerous carbon-containing fuels, in particular natural gas, petrol, methanol and biomass. In this connection the membrane should permit as high an activity as possible of the fuel cell. In particular the methanol oxidation should be particularly high compared to known membranes.

In addition a membrane according to the invention should be able to be produced in a cost-effective and simple manner. Moreover, a further object of the present invention was to provide polymer electrolyte membranes that exhibit a high efficiency, in particular a high conductivity over a wide temperature range. In this connection the conductivity, in particular at high temperatures, should be able to be achieved without an additional wetting.

Furthermore a polymer electrolyte membrane should be provided that has a high mechanical stability, in particular a high modulus of elasticity, a high tensile strength, a low creep and a high fracture resistance.

In addition a further object of the present invention was to provide a membrane that in operation also has a low permeability with respect to a very wide range of fuels, such as for example hydrogen or methanol, in which this membrane should also exhibit a low oxygen permeability.

These objects are achieved by the production of a mixture comprising vinyl-containing phosphonic acid and a polymer electrolyte membrane obtainable from this mixture and a further polymer. Due to the high concentration of polyvinylphosphonic acid, its high chain flexibility and the high acid strength of the polyvinylphosphonic acid the conductivity is based on the Grotthus mechanism and the system thus requires no additional wetting. The polyvinylsulfonic acid, which may also be crosslinked by reactive groups, forms with the high temperature-stable polymer an interpenetrating network. Accordingly the washing-out of the electrolyte by the water that is formed or, in the case of a DMFC, by the aqueous fuel, is significantly reduced. A polymer electrolyte membrane according to the invention thus has a very low methanol permeability and is suitable in particular for use in a DMFC. Accordingly a more permanent operation of a fuel cell is possible with a large number of fuels such as hydrogen, natural gas, petrol, methanol or biomass. In this connection the membranes permit a particularly high activity of these fuels. Due to the high temperatures the methanol oxidation can take place with a high activity. In a particular embodiment these membranes are suitable for use in a so-called vapour-type DMFC, in particular at temperatures in the range from 100° to 200° C.

Due to the possibility of being able to operate at temperatures above 100° C. the sensitivity of the Pt catalyst to gaseous impurities, in particular CO, falls sharply. CO is formed as a by-product in the reforming of the hydrogen-rich gas from carbon-containing compounds, such as for example natural gas, methanol or petrol, or also as an intermediate product in the direct oxidation of methanol. Typically the CO content of the fuel at temperatures above 120° C. may be greater than 5000 ppm without the catalytic action of the Pt catalyst being drastically reduced. At temperatures in the range from 1500 to 200° C. however levels of 10,000 ppm CO or more may also be tolerated (N. J. Bjerrum et al. Journal of Applied Electrochemistry, 2001, 31, 773-779). This leads to significant simplifications in the upstream-connected reforming process and thus to cost savings of the overall fuel cell system.

A membrane according to the invention exhibits a high conductivity over a large temperature range, which is also achieved without any additional wetting. Furthermore a fuel cell that is equipped with a membrane according to the invention can also be operated at low temperatures, for example at 80° C., without the service life of the fuel cell thereby being greatly reduced.

Moreover membranes of the present invention exhibit a high mechanical stability, in particular a high modulus of elasticity, a high tensile strength, a low creep and a high fracture resistance. Besides this these membranes have a surprisingly long service life.

The present invention provides a proton-conducting polymer membrane based on polyvinylphosphonic acid obtainable by a process comprising the following steps:
A) Mixing a polymer with vinyl-containing phosphonic acid,
B) Forming a two-dimensional structure using the mixture according to step A) on a carrier,
C) Polymerisation of the vinyl-containing phosphonic acid present in the two-dimensional structure according to step B).

The polymers used in step A) comprise one or more polymers that in the vinyl-containing phosphonic acid have a solubility of at least 1 wt. %, preferably at least 3 wt. % o, the solubility being dependent on the temperature. The mixture used to form the two-dimensional structure may however be obtained in a wide temperature range, with the result that only the required minimum solubility has to be achieved. The lower temperature limit is determined by the melting point of the liquid contained in the mixture, and the upper temperature limit is generally determined by the decomposition temperatures of the polymers or constituents of the mixture. In general the production of the mixture takes place in a temperature range from 0° to 250° C., preferably 10° to 200° C. Furthermore an elevated pressure may be employed for the dissolution, the limits being determined in this connection by the technical possibilities. Particularly preferably in step A) a polymer is used that has a solubility of at least 1 wt. % in vinyl-containing phosphonic acid at 160° C. and 1 bar.

The preferred polymers include inter alia polyolefins such as poly(chloroprene), polyacetylene, polyphenylene, poly(p-xylylene), polyarylmethylene, polystyrene, polymethylstyrene, polyvinyl alcohol, polyvinyl acetate, polyvinyl ether, polyvinyl amine, poly(N-vinylacetamide), polyvinylimidazole, polyvinylcarbazole, polyvinylpyrrolidone, polyvinyl pyridine, polyvinyl chloride, polyvinylidene chloride, polytetrafluoroethylene, polyhexafluoropropylene, copolymers of PTFE with hexafluoropropylene, with perfluoropropyl vinyl ether, with trifluoronitrosomethane, with carbalkoxy-perfluoroalkoxy vinyl ether, polychlorotrifluoroethylene, polyvinyl fluoride, polyvinylidene fluoride, polyacrolein, polyacrylamide, polyacrylonitrile, polycyanoacrylates, polymethacrylimide, cycloolefinic copolymers, in particular of norbornene; polymers with C—O bonds in the main chain, for example polyacetal, polyoxymethylene, polyethers, polypropylene oxide, polyepichlorohydrin, polytetrahydrofuran, polyphenylene oxide, polyether ketone, polyesters, in particular polyhydroxyacetic acid, polyethylene terephthalate, polybutylene terephthalate, polyhydroxybenzoate, polyhydroxypropionic acid, polypivalolactone, polycaprolactone, polymalonic acid, polycarbonate;
Polymeric C—S bonds in the main chain, for example polysulfide ethers, polyphenylene sulfide, polyethersulfone;
polymeric C—N bonds in the main chain, for example polyimines, polyisocyanides, polyetherimine, polyetherimides, polyaniline, polyaramides, polyamides, polyhydrazides, polyurethanes, polyimides, polyazoles, polyazole ether ketone, polyazines;
liquid crystalline polymers, in particular Vectra, as well as inorganic polymers, for example polysilanes, polycarbosilanes, polysiloxanes, polysilicic acid, polysilicates, silicones, polyphosphazenes and polythiazyl.

According to a particular aspect of the present invention high temperature-stable polymers are used that contain at least one nitrogen, oxygen and/or sulfur atom in a repeating unit or in different repeating units.

High temperature-stable within the meaning of the present invention refers to a polymer that can be permanently used as polymeric electrolyte in a fuel cell at temperatures above 120° C. “Permanently” means that a membrane according to the invention can be operated for at least 100 hours, preferably at least 500 hours at at least 120° C., preferably at at least 160° C., without the output, as measured by the method described in WO 01/18894 A2, falling by more than 50% referred to the initial output.

The polymers used in step A) are preferably polymers that have a glass transition temperature or Vicat softening temperature VST/A/50 of at least 100° C., preferably at least 150° C. and most particularly preferably at least 180° C.

Particularly preferred are polymers that contain at least one nitrogen atom in a repeating unit. Especially preferred are polymers that contain at least one aromatic ring with at least one nitrogen heteroatom per repeating unit. Within this group polymers based on polyazolene are in particular preferred. These basic polyazole polymers contain at least one aromatic ring with at least one nitrogen heteroatom per repeating unit.

The aromatic ring is preferably a 5-membered or 6-membered ring with one to three nitrogen atoms, which may be anellated to another ring, in particular to another aromatic ring.

Polymers based on polyazole contain repeating azole units of the general formula (I) and/or (II) and/or (III) and/or (IV) and/or (V) and/or (VI) and/or (VII) and/or (VIII) and/or (IX) and/or (X) and/or (Xl) and/or (XII) and/or (XIII) and/or (XIV) and/or (XV) and/or (XVI) and/or (XVI) and/or (XVII) and/or (XVIII) and/or (XIX) and/or (XX) and/or (XXI) and/or (XXII) 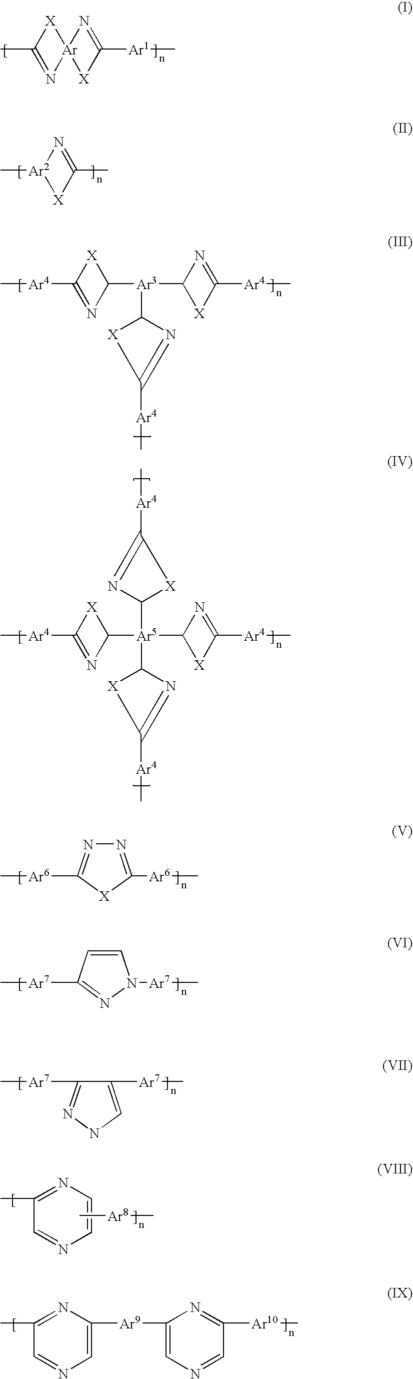 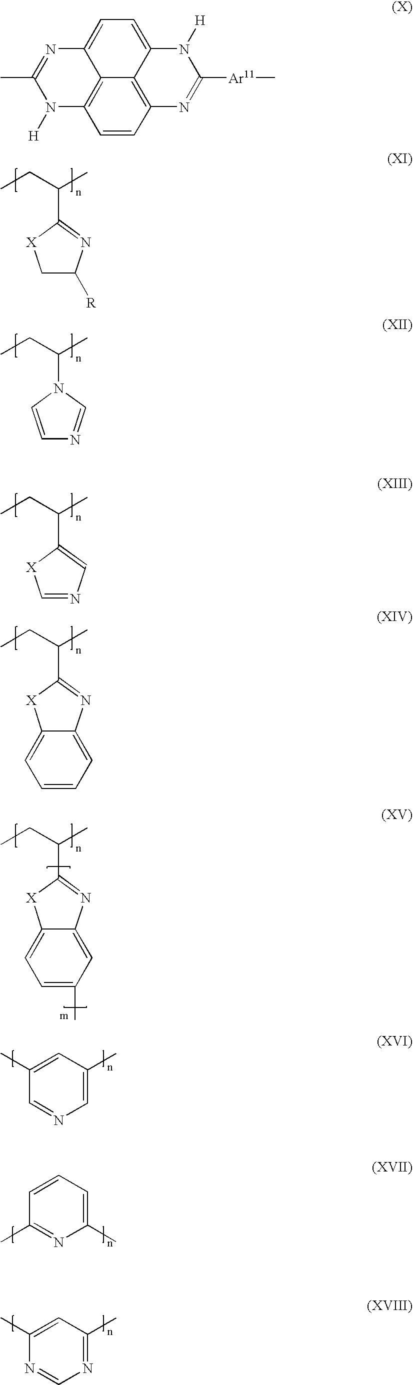 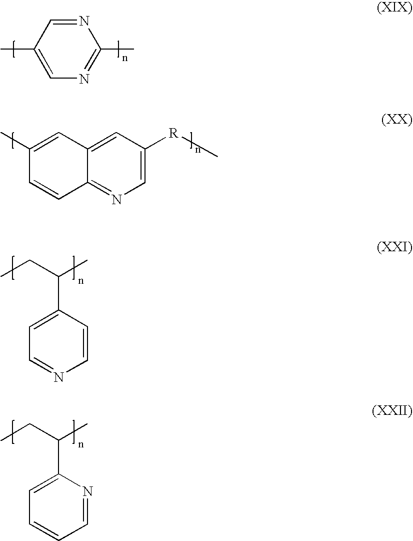
wherein
Ar are identical or different and denote a tetravalent aromatic or heteroaromatic group, which may be mononuclear or polynuclear,
Ar¹ are identical or different and denote a divalent aromatic or heteroaromatic group, which may be mononuclear or polynuclear,
Ar² are identical or different and denote a divalent or trivalent aromatic or heteroaromatic group, which may be mononuclear or polynuclear,
Ar³ are identical or different and denote a trivalent aromatic or heteroaromatic group, which may be mononuclear or polynuclear,
Ar⁴ are identical or different and denote a trivalent aromatic or heteroaromatic group, which may be mononuclear or polynuclear,
Ar⁵ are identical or different and denote a tetravalent aromatic or heteroaromatic group, which may be mononuclear or polynuclear,
Ar⁶ are identical or different and denote a divalent aromatic or heteroaromatic group, which may be mononuclear or polynuclear,
Ar⁷ are identical or different and denote a divalent aromatic or heteroaromatic group, which may be mononuclear or polynuclear,
Ar⁸ are identical or different and denote a trivalent aromatic or heteroaromatic group, which may be mononuclear or polynuclear,
Ar⁹ are identical or different and denote a divalent, trivalent or tetravalent aromatic or heteroaromatic group, which may be mononuclear or polynuclear,
Ar¹⁰ are identical or different and denote a divalent or trivalent aromatic or heteroaromatic group, which may be mononuclear or polynuclear,
Ar¹¹ are identical or different and denote a divalent aromatic or heteroaromatic group, which may be mononuclear or polynuclear,
X are identical or different and denote oxygen, sulfur or an amino group, which carries a hydrogen atom, a 1-20 carbon atom-containing group, preferably a branched or unbranched alkyl group or alkoxy group, or an aryl group, as further radical,
R are identical or different and denote hydrogen, an alkyl group and an aromatic group, and
n, m are a whole number greater than or equal to 10, preferably greater than or equal to 100.

According to the invention preferred aromatic or heteroaromatic groups are derived from benzene, naphthaline, biphenyl, diphenyl ether, diphenylmethane, diphenyldimethylmethane, bisphenone, diphenylsulfone, thiophene, furan, pyrrole, thiazole, oxazole, imidazole, isothiazole, isoxazole, pyrazole, 1,3,4-oxadiazole, 2,5-diphenyl-1,3,4-oxadiazole, 1,3,4-thiadiazole, 1,3,4-triazole, 2,5-diphenyl-1,3,4-triazole, 1,2,5-triphenyl-1,3,4-triazole, 1,2,4-oxadiazole, 1,2,4-thiadiazole, 1,2,4-triazole, 1,2,3-triazole, 1,2,3,4-tetrazole, benzo[b]thiophene, benzo[b]furan, indole, benzo[c]thiophene, benzo[c]furan, isoindole, benzoxazole, benzothiazole, benzimidazole, benzisoxazole, benzisothiazole, benzopyrazole, benzothiadiazole, benzotriazole, dibenzofuran, dibenzothiophene, carbazole, pyridine, bipyridine, pyrazine, pyrazole, pyrimidine, pyridazine, 1,3,5-triazine, 1,2,4-triazine, 1,2,4,5-triazine, tetrazine, quinoline, isoquinoline, quinoxaline, quinazoline, cinnoline, 1,8-naphthyridine, 1,5-naphthyridine, 1,6-naphthyridine, 1,7-naphthyridine, phthalazine, pyridopyrimidine, purine, pteridine or quinolizine, 4H-quinolizine, diphenyl ether, anthracene, benzopyrrole, benzooxathiadiazole, benzooxadiazole, benzopyridine, benzopyrazine, benzopyrazidine, benzopyrimidine, benzotriazine, indolizine, pyridopyridine, imidazopyrimidine, pyrazinopyrimidine, carbazole, aciridine, phenazine, benzoquinoline, phenoxazine, phenothiazine, acridizine, benzopteridine, phenanthroline and phenanthrene, which may optionally also be substituted.

In this connection the substitution pattern of Ar¹, Ar⁴, Ar⁶, Ar⁷, Ar⁸, Ar⁹, Ar¹⁰, Ar¹¹ is arbitrary, and in the case of phenylene for example Ar¹, Ar⁴, Ar⁵, Ar⁷, Ar⁸, Ar⁹, Ar¹⁰, Ar¹¹ may be ortho-phenylene, meta-phenylene and para-phenylene. Particularly preferred groups are derived from benzene and biphenylene, which may optionally also be substituted.

Preferred alkyl groups are short-chain alkyl groups with 1 to 4 carbon atoms, such as e.g. methyl, ethyl, n-propyl or i-propyl and t-butyl groups.

Preferred aromatic groups are phenyl or naphthyl groups. The alkyl groups and the aromatic groups may be substituted.

Preferred substituents are halogen atoms such as for example fluorine, amino groups, hydroxy groups or short-chain alkyl groups such as e.g. methyl or ethyl groups.

Preferred are polyazoles with repeating units of the formula (I) in which the radicals X within a repeating unit are identical.

The polyazoles may in principle also contain different repeating units, which may for example differ in their radical X. Preferably however only identical radicals X are contained in a repeating unit.

In a further embodiment of the present invention the polymer containing repeating azole units is a copolymer or a blend that contains at least two units of the formulae (I) to (XXII), which differ from one another. The polymers may be present as block copolymers (diblock, triblock), random copolymers, periodic copolymers and/or alternating polymers.

The number of repeating azole units in the polymer is preferably a large number, greater than or equal to 10. Particularly preferred polymers contain at least 100 repeating azole units.

Within the scope of the present invention polymers containing repeating benzimidazole units are preferred. Some examples of the extremely suitable polymers containing repeating benzimidazole units are shown by the following formulae: 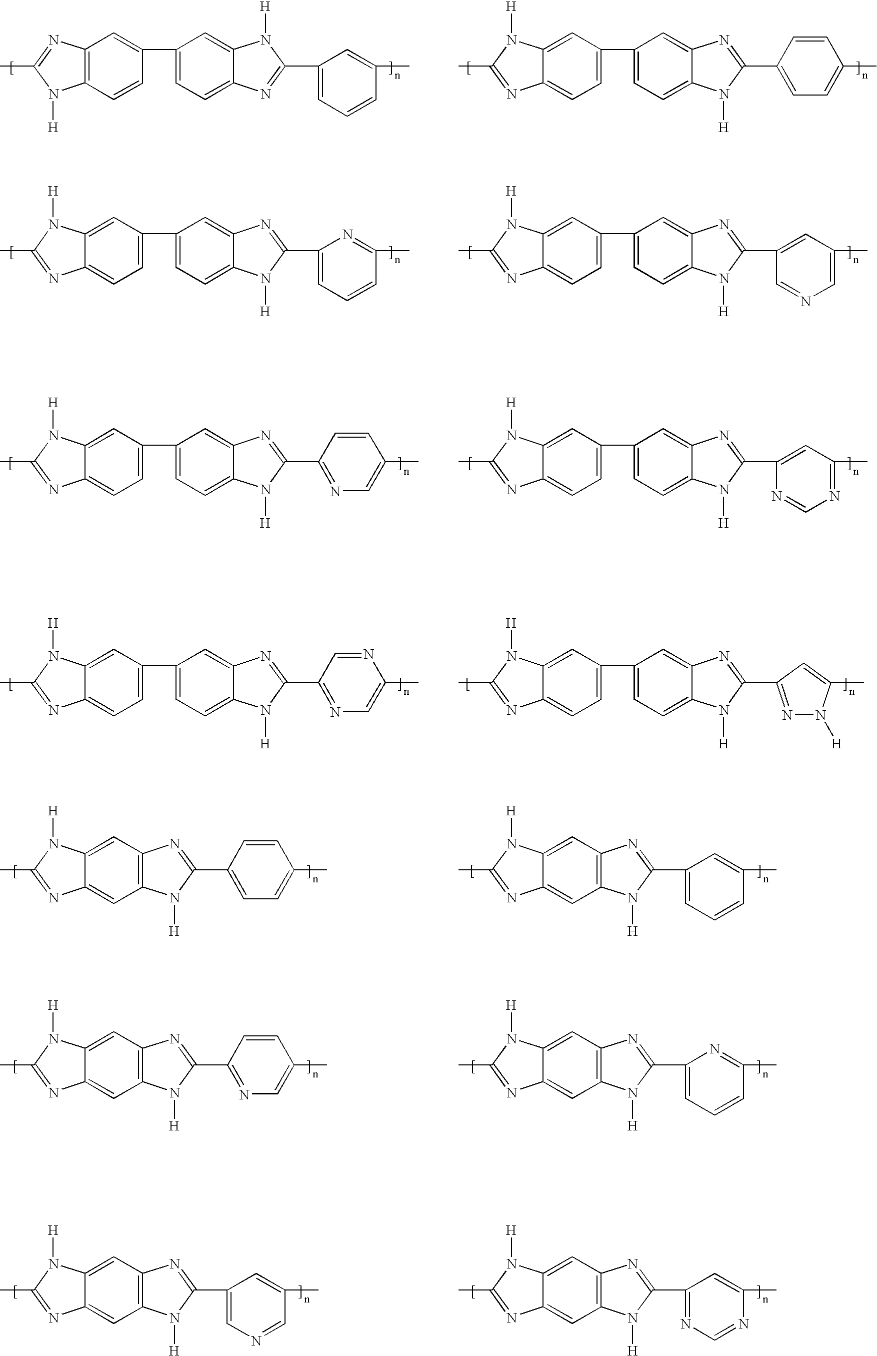 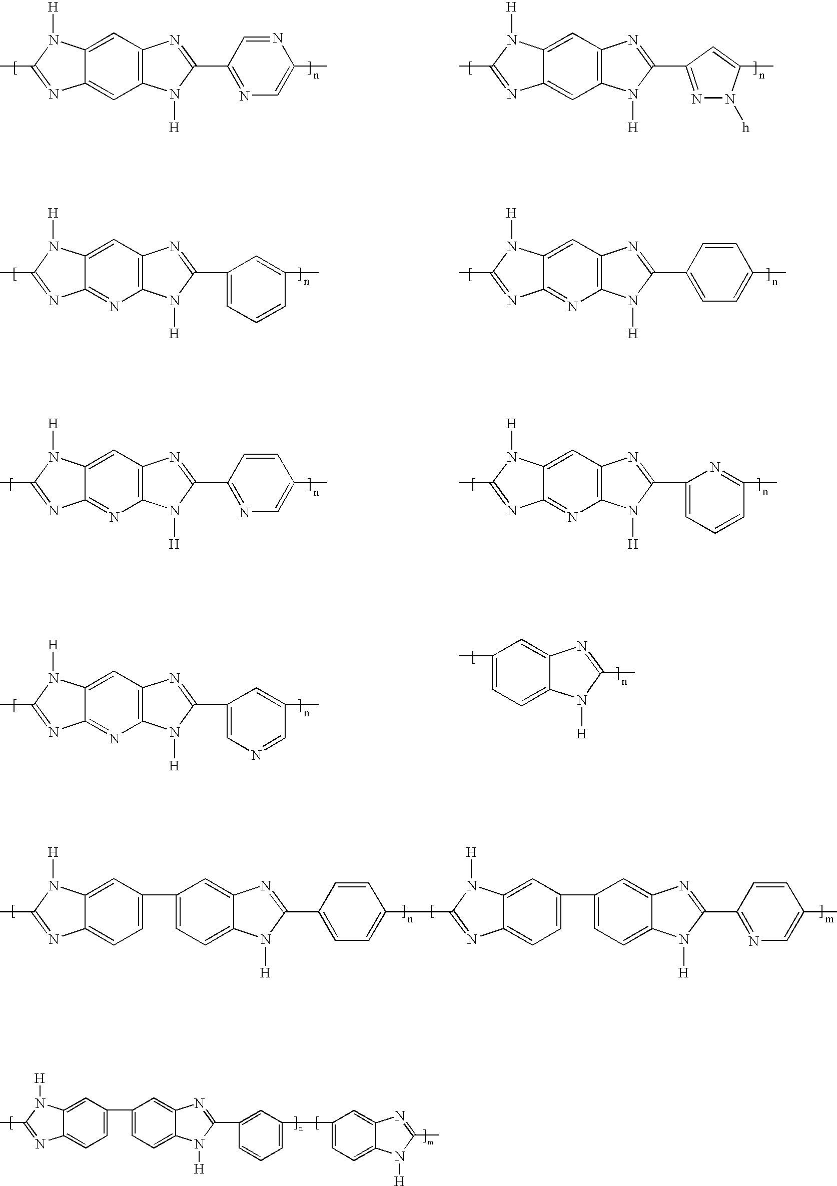
wherein n and m are a whole number greater than or equal to 10, preferably greater than or equal to 100.

The polyazoles used in step A), but in particular the polybenzimidazoles, are characterised by a high molecular weight. Measured as intrinsic viscosity, this is preferably at least 0.2 dl/g, in particular 0.7 to 10 dl/g, particularly preferably 0.8 to 5 dl/g.

Further preferred polyazole polymers are polyimidazoles, polybenzthiazoles, polybenzoxazoles, polytriazoles, polyoxadiazoles, polythiadiazoles, polypyrazoles, polyquinoxalines, poly(pyridines), poly(pyrimidines) and poly(tetrazapyrenes).

Particularly preferred is Celazole from the Celanese company, and in particular a polymer prepared by screening as described in German patent application no. 10129458.1 is used.

Furthermore polyazoles are preferred that have been obtained according to the methods described in German patent application no. 10117687.2.

The preferred polymers include polysulfones, in particular polysulfone with aromatic and/or heteroaromatic groups in the main chain. According to a particular aspect of the present invention preferred polysulfones and polyether sulfones have a melt volume rate MVR 300/21.6 of less than or equal to 40 cm³/10 mins, in particular less than or equal to 30 cm³/10 mins, and particularly preferably less than or equal to 20 cm³/10 mins, measured according to ISO 1133. In this connection polysulfones with a Vicat softening temperature VST/A/50 of 180° C. to 230° C. are preferred. In an even more preferred embodiment of the present invention the number average molecular weight of the polysulfones is greater than 30,000 g/mole.

Polymers based on polysulfone include in particular polymers that comprise repeating units with coupling sulfone groups corresponding to the general formulae A, B, C, D, E, F and/or G: 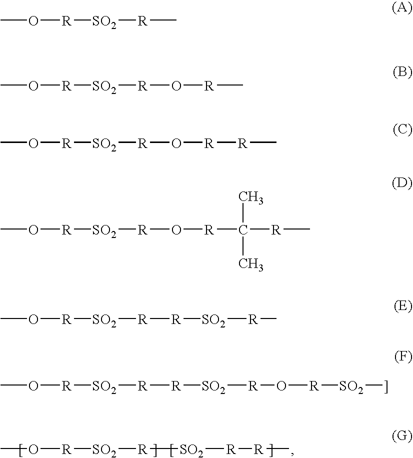
wherein the radicals R independently of one another are identical or different and denote an aromatic or heteroaromatic group, these radicals having been described in more detail hereinbefore. These radicals include in particular 1,2-phenylene, 1,3-phenylene, 1,4-phenylene, 4,4′-biphenyl, pyridine, quinoline, naphthaline, phenanthrene.

Polysulfones preferred within the scope of the present invention include homopolymers and copolymers, for example random copolymers. Particularly preferred polysulfones comprise repeating units of the formulae H to N:

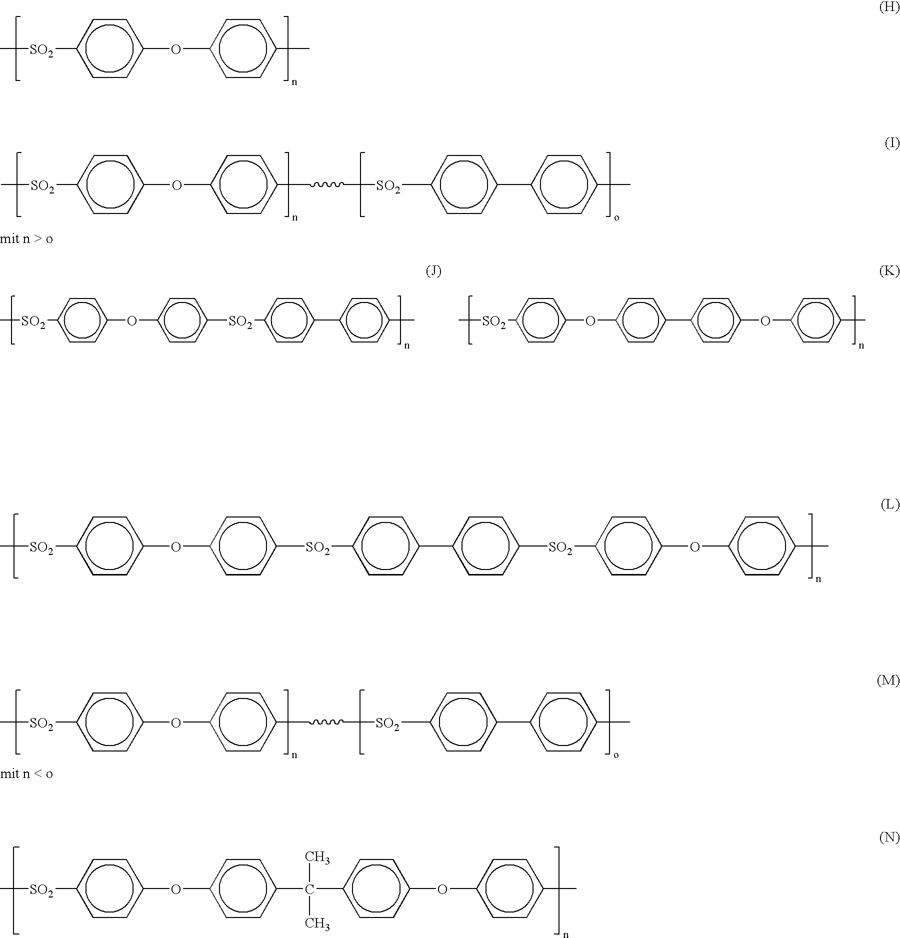

The aforedescribed polysulfones may be commercially obtained under the trade names®Victrex 200 P, ®Victrex 720 P, ®Ultrason E, ®Ultrason S, ®Mindel, ®Radel A, ®Radel R, ®Victrex HTA, ®Astrel and ®Udel.

In addition polyether ketones, polyether ketone ketones, polyether ether ketones, polyether ether ketone ketones and polyaryl ketones are particularly preferred. These high-performance polymers are known per se and may be commercially obtained under the trade names ®Victrex PEEK™, ®Hostatec, ®Kadel.

The polymers mentioned hereinbefore may be used individually or as a mixture (blend). In this connection blends are particularly preferred that contain polyazoles and/or polysulfones. The mechanical properties can be improved and the material costs can be reduced by using blends.

The polymer membranes according to the invention may also contain further additions of fillers and/or auxiliary substances.

In order to improve the application technology processes still further fillers, in particular proton-conducting fillers, as well as additional acids, may additionally also be added to the membrane. The addition may take place for example in step A) and/or step B). Furthermore these additives, if present in liquid form, may also be added after the polymerisation according to step C).

Non-limiting examples of proton-conducting fillers are:
sulfates such as: CsHSO₄, Fe(SO₄)₂, (NH₄)₃H(SO₄)₂, LiHSO₄, NaHSO₄, KHSO₄, RbSO₄, LiN₂H₅SO₄, NH₄HSO₄,
phosphates such as: Zr₃(PO₄)₄, Zr(HPO₄)₂, HZr₂(PO₄)₃, UO₂PO₄.3H₂O, H₈UO₂PO₄, Ce(HPO₄)₂, Ti(HPO₄)₂, KH₂PO₄, NaH₂PO₄, LiH₂PO₄, NH₄H₂PO₄, CsH₂PO₄, CaHPO₄, MgHPO₄, HSbP₂O₈, HSb₃P₂O₁₄, H₅Sb₅P₂O₂₀,
polyacids such as: H₃PW₁₂O₄₀.nH₂O (n=21-29), H₃SiW₁₂O₄₀.nH₂O, (n=21-29), H_{X}WO₃, HSbWO₆, H₃PMo₁₂O₄₀, H₂Sb₄O₁₁, HTaWO₆, HNbO₃, HTiNbO₅, HTlTaO₅, HSbTeO₆, H₅Ti₄O₉, HSbO₃, H₂MoO₄,
selenites and arsenides such as: (NH₄)₃H(SeO₄)₂, UO₂AsO₄, (NH₄)₃H(SeO₄)₂, KH₂AsO₄, Cs₃H(SeO₄)₂, Rb₃H(SeO₄)₂,
oxides such as: Al₂O₃, Sb₂O₅, ThO₂, SnO₂, ZrO₂, MoO₃,
silicates such as: zeolites, zeolites (NH₄⁺), layer silicates, framework silicates, H-natrolites, H-mordenites, NH₄-analcines, NH₄-sodalites, NH₄-gallates, H-montmorillonites,
acids such as: HClO₄, SbF₅,
fillers such as: carbides, in particular SiC, Si₃N₄, fibres, in particular glass fibres, glass powders and/or polymer fibres, preferably based on polyazoles.

These additives may be contained in usual amounts in the proton-conducting polymer membrane, though however the positive properties such as high conductivity, long service life and high mechanical stability of the membrane should not be too greatly adversely affected by addition of excessive amounts of additives. In general the membrane after the polymerisation according to step C) comprises at most 80 wt. %, preferably at most 50 wt. % and particularly preferably at most 20 wt. % of additives.

In addition this membrane may also contain perfluorinated sulfonic acid additives (preferably 0.1-20 wt. %, more preferably 0.2-15 wt. %, most particularly preferably 0.2-10 wt. %). These additives improve the performance, increase the oxygen solubility and oxygen diffusion in the vicinity of the cathode, and reduce the adsorption of phosphoric acid and phosphate on platinum. (Electrolyte additives for phosphoric acid fuel cells. Gang, Xiao; Hjuler, H. A.; Olsen, C.; Berg, R. W.; Bjerrum, N. J. Chem. Depend. A, Tech. Univ. Denmark, Lyngby, Den. J. Electrochem. Soc, (1993), 140 (4), 896-902 and Perfluorosulfonimide as an additive in phosphoric acid fuel cell. Razaq, M.; Razaq, A.; Yeager, E.; DesMarteau, Darryl D.; Singh, S. Case Cent. Electrochem. Sci., Case West. Reserve Univ., Cleveland, Ohio, USA. J. Electrochem. Soc. (1989), 136 (2), 385-90.)

Non-limiting examples of persulfonated additives are: trifluoromethanesulfonic acid, potassium trifluoromethanesulfonate, sodium trifluoromethanesulfonate, lithium trifluoromethanesulfonate, ammonium trifluoromethanesulfonate, potassium perfluorohexanesulfonate, sodium perfluorohexanesulfonate, lithium perfluorohexanesulfonate, ammonium perfluorohexanesulfonate, perfluorohexanesulfonic acid, potassium fluorobutanesulfonate, sodium fluorobutanesulfonate, lithium fluorobutanesulfonate, ammonium nonafluorobutanesulfonate, cesiumnonafluorobutanesulfonate, nonafluorobutanesulfonate, triethyl ammonium perfluorohexasulfonate and perfluorosulfoimide.

Vinyl-containing phosphonic acids are known in specialist circles. These acids are compounds that contain at least one carbon-carbon double bond and at least one phosphonic acid group. Preferably the two carbon atoms that form the carbon-carbon double bond include at least two, preferably three bonds to groups that lead to a low steric hindrance of the double bond. These groups include inter alia hydrogen atoms and halogen atoms, in particular fluorine atoms. Within the scope of the present invention the polyvinylphosphonic acid is formed from the polymerisation product that is obtained by polymerisation of the vinyl-containing phosphonic acid alone or with further monomers and/or crosslinking agents.

The vinyl-containing phosphonic acid may contain one, two, three or more carbon-carbon double bonds. In addition the vinyl-containing phosphonic acid may contain one, two, three or more phosphonic acid groups.

In general the vinyl-containing phosphonic acid contains 2 to 20, preferably 2 to 10 carbon atoms.

The vinyl-containing phosphonic acid used in step A) preferably involves compounds of the formula: 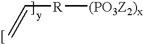
wherein
R denotes a single bond, a C1-C15 alkyl group, C1-C15 alkoxy group, ethyleneoxy group or C5-C20 aryl or heteroaryl group, wherein the above radicals may in turn be substituted by halogen, —OH, —COOZ, —CN, NZ₂,
Z independently of one another denote hydrogen, a C1-C5 alkyl group, C1-C15 alkoxy group, ethyleneoxy group or C5-C20 aryl or heteroaryl group, wherein the aforementioned radicals may in turn be substituted by halogen, —OH, —CN, and
x is a whole number 1, 2, 3, 4, 5, 6, 7, 8, 9 or 10
y is a whole number 1, 2, 3, 4, 5, 6, 7, 8, 9 or 10
   and/or the formula 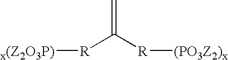
   wherein
R denotes a single bond, a C1-C15 alkyl group, C1-C15 alkoxy group, ethyleneoxy group or C5-C20 aryl or heteroaryl group, wherein the above radicals may in turn be substituted by halogen, —OH, —COOZ, —CN, NZ₂,
Z independently of one another denote hydrogen, a C1-C15 alkyl group, C1-C15 alkoxy group, ethyleneoxy group or C5-C20 aryl or heteroaryl group, wherein the aforementioned radicals may in turn be substituted by halogen, —OH, —CN, and
x is a whole number 1, 2, 3, 4, 5, 6, 7, 8, 9 or 10
   and/or the formula 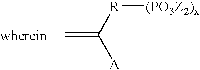
   wherein
A represents a group of the formulae COOR², CN, CONR²₂, OR² and/or R²,
wherein R² denotes hydrogen, a C1-C15 alkyl group, C1-C15 alkoxy group,
   ethyleneoxy group or C5-C20 aryl or heteroaryl group,
   wherein the aforementioned radicals may in turn be substituted by halogen, —OH, COOZ, —CN and NZ₂
R denotes a single bond, a double bond C1-C15 alkylene group, C1-C15 alkyleneoxy group, for example an ethyleneoxy group or double bond C5-C20 aryl or heteroaryl group, wherein the above radicals may in turn be substituted by halogen, —OH, —COOZ, —CN, NZ₂,
Z independently of one another denote hydrogen, a C1-C15 alkyl group, C1-C15 alkoxy group, ethyleneoxy group or C5-C20 aryl or heteroaryl group, wherein the aforementioned radicals may in turn be substituted by halogen, —OH, —CN, and
x is a whole number 1, 2, 3, 4, 5, 6, 7, 8, 9 or 10.

The preferred vinyl-containing phosphonic acids include inter alia alkenes that contain phosphonic acid groups, such as ethenephosphonic acid, propenephosphonic acid, butenephosphonic acid; acrylic acid and/or methacrylic acid compounds, that contain phosphonic acid groups, such as 2-phosphonomethyl acrylic acid, 2-phosphonomethyl methacrylic acid, 2-phosphonomethyl acrylic acid amide and 2-phosphonomethyl methacrylic acid amide.

Particularly preferably commercially available vinylphosphonic acid (ethenephosphonic acid) is used, as is obtainable for example from the Aldrich company or Clariant GmbH. A preferred vinylphosphonic acid has a purity of more than 70%, in particular 90%, and particularly preferably a purity of more than 97%.

The vinyl-containing phosphonic acids may furthermore also be used in the form of derivatives that may subsequently be converted into the acid, in which connection the conversion to the acid may also take place in the polymerised state. These derivatives include in particular the salts, esters, amides and halides of the vinyl-containing phosphonic acids.

The mixture produced in step A) preferably contains at least 10 wt. %, in particular at least 50 wt. % and particularly preferably at least 70 wt. %, referred to the total weight, of vinyl-containing phosphonic acid. According to a particular aspect of the present invention the mixture produced in step A) contains at most 60 wt. % of polymer, in particular at most 50 wt. % of polymer, and particularly preferably at most 30 wt. % of polymer, referred to the total weight.

The mixture produced in step A) may in addition also contain further organic and/or inorganic solvents. The organic solvents include in particular polar aprotic solvents such as dimethyl sulfoxide (DMSO), esters such as ethyl acetate, and polar protic solvents such as alcohols, e.g. ethanol, propanol, isopropanol and/or butanol. The inorganic solvents include in particular water, phosphoric acid and polyphosphoric acid.

These solvents can positively influence the processability. In particular, the solubility of the polymer can be improved by addition of the organic solvent. The content of vinyl-containing phosphonic acid in such solutions is at least 5 wt. %, preferably at least 10 wt. %, particularly preferably between 10 and 97 wt. %.

In a further embodiment of the invention the vinyl-containing phosphonic acid contains further monomers capable of undergoing crosslinking. These monomers are in particular compounds that contain at least two carbon-carbon double bonds. Preferred are dienes, trienes, tetraenes, dimethacrylates, trimethacrylates, tetramethacrylates, diacrylates, triacrylates, tetraacrylates.

Particularly preferred are dienes, trienes and tetraenes of the formula 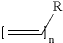
dimethyl acrylates, trimethyl acrylates and tetramethyl acrylates of the formula 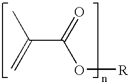
diacrylates, triacrylates and tetraacrylates of the formula 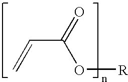
wherein
R denotes a C1-C15 alkyl group, C5-C20 aryl or heteroaryl group, NR′, —SO₂, PR′, Si(R′)₂ wherein the above radicals may in turn be substituted,
R′ independently of one another denotes hydrogen, a C1-C15 alkyl group, C1-C15 alkoxy group, C5-C20 aryl or heteroaryl group, and
n is at least 2.

The substituents of the above radical R are preferably halogen, hydroxyl, carboxy, carboxyl, carboxyl ester, nitrile, amine, silyl or siloxane radicals.

Particularly preferred crosslinking agents are allyl methacrylate, ethylene glycol dimethacrylate, diethylene glycol dimethacrylate, triethylene glycol dimethacrylate, tetraethylene glycol dimethacrylate and polyethylene glycol dimethacrylate, 1,3-butanediol dimethacrylate, glycerol dimethacrylate, diurethane dimethacrylate, trimethylpropanetrimethacrylate, epoxyacrylates, for example ebacryl, N′N-methylenebisacrylamide, carbinol, butadiene, isoprene, chloroprene, divinylbenzene and/or bisphenol A/dimethyl acrylate. These compounds are commercially obtainable for example from the Sartomer Company Exton, Pennsylvania, under the references CN-120, CN-104 and CN-980.

The use of crosslinking agents is optional, though these compounds may normally be used in amounts between 0.05 to 30 wt. %, preferably 0.1 to 20 wt. %, particularly preferably 0.1 to 10 wt. %, referred to the vinyl-containing phosphonic acid.

The mixture of the polymer produced in step A) may be a solution, in which connection dispersed or suspended polymer may in addition also be contained in this mixture.

The formation of the two-dimensional structure according to step B) is carried out by techniques known per se (casting, spraying, knife coating, extrusion) that are known from the prior art for the production of polymer films. Accordingly the mixture is suitable for forming a two-dimensional structure. The mixture may correspondingly be a solution or a suspension, in which the proportion of sparingly soluble constituents is restricted to amounts that permit the formation of two-dimensional structures. Suitable as carriers are all carriers known to be inert under the relevant conditions. These carriers include in particular films of polyethylene terephthalate (PET), polytetrafluoroethylene (PTFE), polyhexfluoropropylene, copolymers of PTFE with hexafluoropropylene, polyimides, polyphenylene sulfides (PPS) and polypropylene (PP).

In order to adjust the viscosity water and/or a readily vapourisable organic solvent may optionally be added to the mixture. In this way the viscosity can be adjusted to the desired value and the formation of the membrane can be facilitated. The thickness of the two-dimensional structure is generally between 15 and 2000 μm, preferably between 30 and 1500 μm, in particular between 50 and 1200 μm, though these figures are not meant to be limiting.

The polymerisation of the vinyl-containing phosphonic acid in step C) is preferably carried out by free radicals. The formation of free radicals may be effected thermally, photochemically, chemically and/or electrochemically.

For example a starter solution that contains at least one substance capable of forming free radicals may be added to the mixture according to step A). In addition a starter solution may be applied to the two-dimensional structure formed in step B). This application may take place by methods known per se (e.g. spraying, dipping, etc.) that are known from the prior art.

Suitable free radical-forming agents include inter alia azo compounds, peroxy compounds, persulfate compounds or azoamidines. Non-limiting examples are dibenzoyl peroxide, dicumene peroxide, cumene hydroperoxide, diisopropyl peroxydicarbonate, bis(4-t-butylcyclohexyl)peroxy dicarbonate, dipotassium persulfate, ammonium peroxydisulfate, 2,2′-azobis(2-methylpropionitrile) (AlBN), 2,2′-azobis(isobutyric acid amidine) hydrochloride, benzpinacol, dibenzyl derivatives, methylethylene ketone peroxide, 1,1-azobiscyclohexanecarbonitrile, methylethyl ketone peroxide, acetylacetone peroxide, dilauryl peroxide, didecanoyl peroxide, tert.-butylper-2-ethylhexanoate, ketone peroxide, methylisobutyl ketone peroxide, cyclohexanone peroxide, dibenzoyl peroxide, tert.-butylperoxybenzoate, tert.-butylperoxyisopropyl carbonate, 2,5-bis(2-ethylhexanoylperoxy)-2,5-dimethylhexane, tert.-butylperoxy-2-ethylhexanoate, tert.-butylperoxy-3,5,5-trimethylhexanoate, tert.-butylperoxyisobutyrate, tert.-butylperoxyacetate, dicumyl peroxide, 1,1-bis(tert.-butylperoxy) cyclohexane, 1,1-bis(tert.-butylperoxy)3,3,5-trimethylcyclohexane, cumyl hydroperoxide, tert.-butyl hydroperoxide, bis(4-tert.-butylcyclohexyl)-peroxydicarbonate, as well as the free radical-forming agents obtainable from DuPont under the name ®Vazo, for example ®Vazo V50 and ®Vazo WS.

In addition free radical-forming agents that form free radicals on irradiation may also be used. The preferred compounds include inter alia, α,α-diethoxyacetophenone (DEAP, Upjohn Corp.), n-butylbenzoin ether (®Trigonal-14, AKZO), 2,2-dimethoxy-2-phenylacetophenone (®Irgacure 651), 1-benzoylcyclohexanol (®Irgacure 184), bis(2,4,6-trimethylbenzoyl) phenlyphosphine oxide ®Irgacure 819) and 1-[4-(2-hydroxyethoxy)phenyl]-2-hydroxy-2-phenylpropan-1-one ®Irgacure 2959), which are commercially obtainable in each case from Ciba Geigy Corp.

Normally between 0.0001 and 5 wt. %, in particular 0.01 to 3 wt. % (referred to the vinyl-containing phosphonic acid) of free radical-forming agents are added. The amount of free radical-forming agents may be varied depending on the desired degree of polymerisation.

The polymerisation may also be effected by the action of IR or NIR (IR=infrared, i.e. a light with a wavelength of more than 700 nm; NIR=near IR, i.e. light with a wavelength in the range from ca. 700 to 2000 nm, or an energy in the range from ca. 0.6 to 1.75 eV).

The polymerisation may furthermore be effected by the action of UV light with a wavelength of less than 400 nm. This polymerisation method is known per se and is described for example in Hans Joerg Elias, Makromolekulare Chemie, 5^{th} Edition, Vol. 1, pp. 492-511; D. R. Arnold, N. C. Baird, J. R. Bolton, J. C. D. Brand, P. W. M. Jacobs, P. de Mayo, W. R. Ware, Photochemistry—An Introduction, Academic Press, New York and M. K. Mishra, Radical Photopolymerization of Vinyl Monomers, J. Macromol. Sci.—Revs. Macromol. Chem. Physical. C22 (1982-1983) 409.

The polymerisation may also be achieved by the action of β or γ rays and/or electron beams. According to a particular embodiment of the present invention a membrane is irradiated with a radiation dose in the range from 1 to 300 kGy, preferably 3 to 200 kGy and most particularly preferably 20 to 100 kGy.

The polymerisation of the vinyl-containing phosphonic acid in step C) preferably takes place at temperatures above room temperature (20° C.) and below 200° C., in particular at temperatures between 40° C. and 150° C. and particularly preferably between 50° C. and 120° C. The polymerisation is preferably carried out under normal pressure, though it may also take place under elevated pressure. The polymerisation leads to a hardening of the two-dimensional structure, in which connection this hardening may be monitored by microhardness measurements. Preferably the increase in hardness produced by the polymerisation is at least 20% referred to the hardness of the two-dimensional structure obtained in step B).

According to a particular embodiment of the present invention the membranes have a high mechanical stability. This quantity is determined from the hardness of the membrane, which in turn is obtained by microhardness measurements according to DIN 50539. For this purpose the membrane is loaded with a Vickers diamond successively up to a force of 3 mN within 20 sec and the penetration depth is determined. Accordingly the hardness at room temperature is at least 0.01 N/mm², preferably at least 0.1 N/mm² and most particularly preferably at least 1 N/mm², though this is not intended to indicate a restriction. The force is then held constant at 3 mN for 5 sec and the creep is calculated from the penetration depth. With preferred membranes the creep CHU 0.003/20/5 under these conditions is less than 20%, preferably less than 10% and most particularly preferably less than 5%. The modulus YHU determined by means of the microhardness measurement is at least 0.5 MPa, in particular at least 5 MPa and most particularly preferably at least 10 MPa, though this is not intended to indicate a restriction.

Depending on the desired degree of polymerisation the two-dimensional structure that is obtained by the swelling of the polymer film and subsequent polymerization is a self-supporting membrane. Preferably the degree of polymerisation is at least 2, in particular at least 5, particularly preferably at least 30 repeating units, especially at least 50 repeating units, and most particularly preferably at least 100 repeating units. This degree of polymerisation is determined by the number average molecular weight Mₙ, which in turn may be measured by GPC methods. On account of the problem of isolating without decomposition the polyvinylphosphonic acid contained in the membrane, this value is determined on the basis of a sample, which is carried out by polymerisation of vinylphosphonic acid without solvent and without addition of polymer. In this connection the weight proportion of vinylphosphonic acid and of free radical starter is maintained constant compared to the ratios after dissolution of the membrane. The conversion which is achieved in a comparison polymerisation is preferably greater than or equal to 20%, in particular greater than or equal to 40% and particularly preferably greater than or equal to 75%, referred to the vinyl-containing phosphonic acid that is used.

The polymerisation in step C) may lead to a decrease of the layer thickness. Preferably the thickness of the self-supporting membrane is between 15 and 1000 μm, preferably between 20 and 500 μm, in particular between 30 and 250 μm.

The polymer membrane according to the invention contains between 0.5 and 97 wt. % of the polymer as well as between 99.5 and 3 wt. % of polyvinylphosphonic acid. Preferably the polymer membrane according to the invention contains between 3 and 95 wt. % of the polymer as well as between 97 and 5 wt. % of polyvinylphosphonic acid, particularly preferably between 5 and 90 wt. % of the polymer as well as between 95 and 10 wt. % of polyvinylphosphonic acid. In addition the polymer membrane according to the invention may also contain further fillers and/or auxiliary substances.

Following the polymerisation according to step C) the membrane may be thermally, photochemically, chemically and/or electrochemically crosslinked on the surface. This hardening of the membrane surface in addition improves the properties of the membrane.

According to a particular aspect the membrane may be heated to a temperature of at least 150° C., preferably at least 200° C. and particularly preferably at least 250° C. The thermal crosslinking is preferably carried out in the presence of oxygen. The oxygen concentration in this process step is normally in the range from 5 to 50 vol. %, preferably 10 to 40 vol. %, though this is not intended to indicate a restriction.

The crosslinking may also take place under the action of IR or NIR (IR=infrared, i.e. light with a wavelength of more than 700 nm; NIR=near IR, i.e. light with a wavelength in the range from ca. 700 to 2000 nm, or an energy in the range from ca. 0.6 to 1.75 eV) and/or UV light. A further method is irradiation with β or γ rays and/or electron beams. The radiation dose is in this connection preferably between 5 and 200 kGy, in particular 10 to 100 kGy. The irradiation may take place in air or under an inert gas. In this way the use properties of the membrane, in particular its durability, are improved.

Depending on the desired degree of crosslinking the duration of the crosslinking reaction may lie within a wide range. In general this reaction time is in the range from 1 second to 10 hours, preferably 1 minute to 1 hour, though this is not intended to indicate a restriction.

The polymer membrane according to the invention has improved material properties compared to the hitherto known doped polymer membranes. In particular It already has an intrinsic conductivity compared to known undoped polymer membranes. This is due in particular to a present polymeric polyvinylphosphonic acid.

The intrinsic conductivity of the membrane according to the invention at a temperature of 160° C. is generally at least 0.001 S/cm, preferably at least 10 mS/cm, in particular at least 15 mS/cm and particularly preferably at least 20 mS/cm. These values are achieved without wetting. The specific conductivity is measured by means of impedance spectroscopy in a 4-pole arrangement in potentiostatic mode and using platinum electrodes (platinum wire, 0.25 mm diameter). The distance between the current-collecting electrodes is 2 cm. The resultant spectrum is evaluated by a simple model consisting of a parallel arrangement without an ohmic resistor and a capacitor. The sample cross-section of the phosphoric acid-doped membrane is measured immediately before assembly of the sample. In order to measure the temperature dependence the measurement cell is heated to the desired temperature in a furnace and is regulated by means of a Pt-100 thermocouple positioned in the immediate vicinity of the sample. After reaching the temperature the sample is held at this temperature for 10 minutes before starting the measurement.

According to a particular embodiment the membranes according to the invention have a particularly low methanol permeability (methanol crossover). This quantity can be expressed via the crossover current density.

The crossover current density under operation with a 0.5 M methanol solution and at 90° C. in a so-called liquid direct methanol fuel cell is preferably less than 100 mA/cm², in particular less than 70 mA/cm², particularly preferably less than 50 mA/cm² and most particularly preferably less than 10 mA/cm². The crossover current density under operation with a 2 M methanol solution and at 160° C. in a so-called gaseous direct methanol fuel cell is preferably less than 100 mA/cm², in particular less than 50 mA/cm² and most particularly preferably less than 10 mA/cm².

In order to determine the crossover current density the amount of carbon dioxide that is released at the cathode is measured by means of a CO₂ sensor. The crossover current density is calculated from the value of the CO₂ amount thus obtained, as described by P. Zelenay, S. C. Thomas, S. Gottesfeld in S. Gottesfeld, T. F. Fuller, “Proton Conducting Membrane Fuel Cells II” ECS Proc. Vol. 98-27 pp. 300-308.

The present invention also relates to a membrane-electrode unit that comprises at least one polymer membrane according to the invention. The membrane-electrode unit has a high efficiency even with a low content of catalytically active substances, such as for example platinum, ruthenium or palladium. For this purpose gas diffusion units provided with a catalytically active layer may be used.

The gas diffusion unit generally exhibits an electron conductivity. Two-dimensional, electrically conducting and acid-resistant structures are normally used for this purpose. Such structures include for example carbon fibre papers, graphitised carbon fibre papers, carbon fibre fabrics, graphitised carbon fibre fabrics and/or two-dimensional structures that have been made electrically conducting by addition of carbon black.

The catalytically active layer contains a catalytically active substance. Catalytically active substances include inter alia, noble metals, in particular platinum, palladium, rhodium, iridium and/or ruthenium. These substances may also be used in the form of alloys with one another. Furthermore these substances may also be used as alloys with base metals, such as for example Cr, Zr, Ni, Co and/or Ti. Moreover, the oxides of the previously mentioned noble metals and/or base metals may also be used. According to a particular aspect of the present invention the catalytically active compounds are used in the form of particles that preferably have a size in the range from 1 to 1000 nm, in particular 10 to 200 nm and preferably 20 to 100 nm.

The catalytically active particles that include the previously mentioned substances may be employed as metal powder, so-called black noble metal, in particular platinum and/or platinum alloys. Such particles generally have a size in the range from 5 nm to 200 nm, preferably in the range from 10 nm to 100 nm.

Furthermore the metals may also be used on a carrier material. Preferably this carrier material comprises carbon, which may be employed in particular in the form of carbon black, graphite or graphitised carbon black. The metal content of these supported particles, referred to the total weight of the particles, is generally in the range from 1 to 80 wt. %, preferably 5 to 60 wt. % and particularly preferably 10 to 50 wt. %, though this is not intended to indicate a restriction. The particle size of the carrier, in particular the size of the carbon particles, is preferably in the range from 20 to 100 nm, in particular 30 to 60 nm. The size of the metal particles located thereon is preferably in the range from 1 to 20 nm, in particular 1 to 10 nm and particularly preferably 2 to 6 nm.

The sizes of the various particles represent mean values of the average weight and may be determined by transmission electron microscopy.

The catalytically active particles listed hereinbefore may in general be obtained commercially.

Furthermore the catalytically active layer may contain conventional additives. These include inter alia fluorinated polymers such as e.g. polytetrafluoroethylene (PTFE) and surface-active substances.

The surface-active substances include in particular ionic surfactants, for example fatty acid salts, in particular sodium laurate and potassium oleate; and alkylsulfonic acids, alkylsulfonic acid salts, in particular sodium perfluorohexanesulfonate, lithium perfluorohexanesulfonate, ammonium perfluorohexanesulfonate, perfluorohexanesulfonic acid, potassium nonafluorobutanesulfonate, as well as non-ionic surfactants, in particular ethoxylated fatty alcohols and polyethylene glycols.

Particularly preferred additives are fluorinated polymers, in particular tetrafluoroethylene polymers. According to a particular embodiment of the present invention the weight ratio of fluorinated polymer to catalyst material, comprising at least one noble metal and optionally one or more carrier materials, is greater than 0.1, this ratio preferably being in the range from 0.2 to 0.6.

According to another particular embodiment of the present invention the catalyst layer has a thickness in the range from 1 to 1000 μm, in particular from 5 to 500 μm, preferably from 10 to 300 μm. This value represents a mean value, which can be determined by measuring the layer thickness in cross-section from images that can be obtained with a scanning electron microscope (SEM).

According to yet a further particular embodiment of the invention the noble metal content of the catalyst layer is 0.1 to 10.0 mg/cm², preferably 0.3 to 6.0 mg/cm² and particularly preferably 0.3 to 3.0 mg/cm². These values may be determined by elementary analysis of a two-dimensional sample.

The production of a membrane-electrode unit may be carried out inter alia by hot pressing. For this, the composite of electrode consisting of gas diffusion units provided with catalytically active layers and a membrane is heated to a temperature in the range from 50° C. to 200° C. and compressed at a pressure of 0.1 to 5 MPa. In general a few seconds are sufficient to bond the catalyst layer to the membrane. Preferably this time is in the range from 1 second to 5 minutes, in particular 5 seconds to 1 minute.

The present invention also provides a proton-conducting polymer membrane according to the invention coated with a catalyst layer.

Various methods may be used for applying a catalyst layer to the membrane. Thus, for example, a carrier may be used that is provided with a coating containing a catalyst in order to provide the membrane according to the invention with a catalyst layer.

In this connection the membrane may be provided on one or both sides with a catalyst layer. If the membrane is provided with a catalyst layer on only one side then the opposite side of the membrane must be compressed with an electrode that comprises a catalyst layer. If both sides of the membrane are to be provided with a catalyst layer, the following methods may also be used in combination in order to achieve an optimal result.

According to the invention the catalyst layer may be applied by a method in which a catalyst suspension is used. Furthermore powders that contain the catalyst may also be employed.

The catalyst suspension contains a catalytically active substance. These substances have been described in more detail hereinbefore in connection with the catalytically active layer.

Furthermore the catalyst suspension may contain conventional additives. These include inter alia fluorinated polymers such as e.g. polytetrafluoroethylene (PTFE), thickening agents, in particular water-soluble polymers such as e.g. cellulose derivatives, polyvinyl alcohol, polyethylene glycol and surface-active substances, which have been discussed previously in connection with the catalytically active layer.

In addition the catalyst suspension may contain constituents that are liquid at room temperature. These include inter alia organic solvents, which may be polar or non-polar, phosphoric acid, polyphosphoric acid and/or water. The catalyst suspension preferably contains 1 to 99 wt. %, in particular 10 to 80 wt. % of liquid constituents.

The polar, organic solvents include in particular alcohols such as ethanol, propanol, isopropanol and/or butanol. The organic, non-polar solvents include inter alia known thin-layer diluents such as thin-layer diluent 8470 from DuPont, which contains terpentine oils.

Particularly preferred additives are fluorinated polymers, in particular tetrafluoroethylene polymers. According to a particular embodiment of the present invention the weight ratio of fluorinated polymer to catalyst material, comprising at least one noble metal and optionally one or more carrier materials, is greater than 0.1, this ratio preferably being in the range from 0.2 to 0.6.

The catalyst suspension may be applied by conventional methods to the membrane according to the invention. Depending on the viscosity of the suspension, which may also exist in paste form, various methods are known by means of which the suspension can be applied. Suitable are methods for coating films, fabrics, textiles and/or papers, in particular spray methods and printing methods, such as for example screen printing and silk screen printing, inkjet methods, roller application, in particular screen printing rollers, slit nozzle application and knife blade application. The respective method as well as the viscosity of the catalyst suspension depends on the hardness of the membrane.

The viscosity can be influenced by the solids content, in particular by the proportion of catalytically active particles and the proportion of additives. The viscosity to be adjusted depends on the application method of the catalyst suspension, the optimum values as well as its determination being common knowledge to the person skilled in the art.

Depending on the hardness of the membrane an improvement of the bonding of the catalyst membrane can be achieved by heating and/or compressing.

According to a particular aspect of the present invention the catalyst layer is applied by a powder method. In this, a catalyst powder is used that may contain additional additives, which have been discussed beforehand by way of example. In order to apply the catalyst powder inter alia spray methods and screen methods may be used. In the screen method the powder mixture is sprayed onto the membrane with a nozzle, for example a slit nozzle. In general the membrane provided with a catalyst layer is then heated in order to improve the bonding between the catalyst and membrane. The heating may be effected for example by a hot roller. Such methods as well as devices for applying the powder are described inter alia in DE 195 09 748, DE 195 09 749 and DE 197 57 492.

In the screen method the catalyst powder is applied by means of a vibrating screen to the membrane. A device for applying a catalyst powder to a membrane is described in WO 00/26982. After the application of the catalyst powder the bonding of the catalyst and membrane can be improved by heating. In this connection the membrane provided with at least one catalyst layer may be heated to a temperature in the range from 50° to 200° C., in particular 100° to 180° C.

Moreover the catalyst layer may be applied by a method in which a coating containing a catalyst is applied to a carrier and the catalyst-containing coating located on the carrier is then transferred to the membrane according to the invention. Such a method is described by way of example in WO 92/15121.

The carrier provided with a catalyst coating may be produced for example by preparing a previously described catalyst suspension. This catalyst suspension is then applied to a carrier film, for example of polytetrafluoroethylene. After the application of the suspension the volatile constituents are removed.

The transfer of the coating containing a catalyst may be carried out inter alia by hot pressing. For this, the composite comprising a catalyst layer and a membrane as well as a carrier film is heated to a temperature in the range from 50° to 200° C. and compressed at a pressure of 0.1 to 5 MPa. In general a few seconds are sufficient in order to bond the catalyst layer to the membrane. Preferably this time is in the range from 1 second to 5 minutes, in particular 5 seconds to 1 minute.

According to a particular embodiment of the present invention the catalyst layer has a thickness in the range from 1 to 1000 μm, in particular 5 to 500 μm, preferably 10 to 300 μm. This value represents a mean value, which can be determined by measuring the layer thickness in the cross-section of images that can be obtained by a scanning electron microscope (SEM).

According to a particular embodiment of the present invention the membrane 5 provided with at least one catalyst layer comprises 0.1 to 10.0 mg/cm², preferably 0.3 to 6.0 mg/cm² and particularly preferably 0.3 to 3.0 mg/cm². These values may be determined by elementary analysis of a two-dimensional sample.

Following the coating with a catalyst the resultant membrane can be photochemically, chemically and/or electrochemically crosslinked. This hardening of the membrane surface in addition improves the properties of the membrane. For this purpose the membrane may be heated to a temperature of at least 150° C., preferably at least 200° C. and particularly preferably at least 250° C. According to a particular embodiment the thermal crosslinking is preferably carried out in the presence of oxygen. The oxygen concentration in this process step is normally in the range from 5 to 50 vol. %, preferably 10 to 40 vol. %, though this is not intended to indicate a restriction.

The crosslinking may also take place under the action of IR or NIR (IR=infrared, i.e. light with a wavelength of more than 700 nm; NIR=near IR, i.e. light with a wavelength in the range from ca. 700 to 2000 nm, or an energy in the range from ca. 0.6 to 1.75 eV) and/or UV light. A further method is irradiation with β or γ rays and/or electron beams. The radiation dose is in this connection preferably between 5 and 200 kGy, in particular 10 to 100 kGy. The irradiation may take place in air or under an inert gas. In this way the use properties of the membrane, in particular its durability, are improved.

Depending on the desired degree of crosslinking the duration of the crosslinking reaction may lie within a wide range. In general this reaction time is in the range from 1 second to 10 hours, preferably 1 minute to 1 hour, though this is not intended to indicate a restriction.

The polymer membrane according to the invention coated with catalyst has improved material properties compared to the hitherto known doped polymer membranes. In particular it has better performance values compared to known doped polymer membranes. This is due in particular to a better contact between the membrane and catalyst.

In order to produce a membrane-electrode unit the membrane according to the invention may be connected to a gas diffusion unit. If the membrane is provided on both sides with a catalyst layer, the gas diffusion unit must not contain any catalyst before the pressing stage.

A membrane-electrode unit according to the invention has a surprisingly high power density. According to a particular embodiment preferred membrane-electrode units provide a current density of at least 0.1 A/cm², preferably 0.2 A/cm², particularly preferably 0.3 A/cm². This current density is measured under operation with pure hydrogen at the anode and air (ca. 20 vol. % oxygen, ca. 80 vol. % nitrogen) at the cathode at normal pressure (absolute 1013 mbar, with open cell output) and 0.6 V cell voltage. In this connection particularly high temperatures in the range from 150° to 200° C., preferably 160° to 180° C. and in particular 170° C. may be employed.

The aforementioned power densities may also be achieved with a lesser stoichiometry of the fuel gases on both sides. According to a particular aspect of the present invention the stoichiometry is less than or equal to 2, preferably less than or equal to 1.5, and most particularly preferably less than or equal to 1.2.

According to a particular embodiment of the present invention the catalyst layer has a low noble metal content. The noble metal content of a preferred catalyst layer, which is comprised by a membrane according to the invention, is preferably at most 2 mg/cm², in particular at most 1 mg/cm², most particularly preferably at most 0.5 mg/cm². According to a particular aspect of the present invention one side of a membrane has a higher metal content than the opposite side of the membrane. Preferably the metal content of one side is at least twice as high as the metal content of the opposite side.

In a variant of the present invention the membrane formation may also take place directly on the electrode instead of on a carrier. The treatment according to step C) may thereby be correspondingly shortened or alternatively the amount of starter solution can be reduced since the membrane no longer has to be self-supporting. Such a membrane or an electrode that is coated with such a polymer membrane according to the invention is also covered by the present invention.

Furthermore it is also possible to carry out the polymerisation of the vinyl-containing phosphonic acid in the laminated membrane-electrode unit. For this, the solution is applied to the electrode and brought into contact with the second, optionally likewise coated electrode, and pressed. The polymerisation is then carried out in the laminated membrane-electrode unit as described hereinbefore.

The coating has a thickness between 2 and 500 μm, preferably between 5 and 300 μm, in particular between 10 and 200 μm. This permits the use in so-called micro fuel cells, in particular in DMFC micro fuel cells.

Such a coated electrode may be incorporated in a membrane-electrode unit that optionally comprises at least one polymer membrane according to the invention.

In a further variant a catalytically active layer may be applied to the membrane according to the invention and this may be connected to a gas diffusion unit. For this, a membrane is formed according to the steps A) to C) and the catalyst is applied. In a variant the catalyst may be applied before or together with the starter solution. These structures are also covered by the present invention.

In addition the formation of the membrane according to the steps A), B) and C) may also take place on a carrier or on a carrier film that already contains the catalyst. After removing the carrier or carrier film the catalyst is located on the membrane according to the invention. These two-dimensional structures too are covered by the present invention.

A membrane-electrode unit that contains at least one polymer membrane according to the invention optionally in combination with a further polymer membrane based on polyazoles or a polymer blend membrane is also covered by the present invention.

Possible areas of use of the polymer membranes according to the invention include interalia applications in fuel cells, in electrolysis, in capacitors and in battery systems. On account of their property profile the polymer membranes are preferably used in fuel cells.

### EXPERIMENTAL EXAMPLES

### Example 1

### Process for the Production of a PBI-VPA Mixture

A polybenzimidazole (PBI) polymer with an intrinsic viscosity of 0.8 dl/g is dissolved in dimethylacetamide as described in DE 10052237.8 so as to form a 16% PBI-DMAc solution. The PBI polymer is then precipitated from this solution while stirring vigorously and under addition of water and is filtered off through a glass filter crucible. The moist polymer thereby obtained is then treated for 16 hours at 50° C. in a crystallisation dish so that the residual moisture is 86%. 270 g of the PBI polymer thereby obtained are then placed in a plane ground flask. To this are added 720 g of vinylphosphonic acid (97%) obtainable from Clariant. A mixture is prepared by slowly stirring at 175° C. for 4 hours.

### Example 2

### Process for the Production of a Membrane

The mixture according to Example 1 is knife-coated at 150° C. onto a carrier of polyethylene terephthalate and a non-self-supporting membrane is obtained. This non-self-supporting membrane is placed for 20 hours at room temperature in a solution consisting of 1.25 g of an aqueous solution containing 5% of 2,2′-azo-bis-(isobutyric acid amidine) hydrochloride, 50 g of vinylphosphonic acid (97%) obtainable from Clariant, and 0.356 g of N,N′-methylenebisacrylamide. The membrane is then treated for 3 hours at 130° C. The membrane that is thus obtained has a thickness of 180 μm. The conductivity results of such a membrane measured by means of impedance spectroscopy are summarised in Table 1. The mechanical properties (modulus of elasticity, hardness HU and creep Cr) were determined by means of microhardness measurements after the thermal treatment. For this, the membrane is loaded with a Vickers diamond successively up to a force of 3 mN within 20 sec and the penetration depth is determined. The force is then held constant at 3 mN for 5 sec and the creep is calculated from the penetration depth. The properties of these membranes are summarised in Table 2.

TABLE 1
Conductivity of a PBI-VPA membrane produced from a PBI-VPA solution

| T [° C.] | 25 | 40 | 60 | 80 | 100 | 120 | 140 | 160 |
|---|---|---|---|---|---|---|---|---|
| Specific | 8.1 | 4.9 | 6.6 | 10.3 | 17.3 | 24.4 | 29.9 | 31.8 |
| conductivity | | | | | | | | |
| [mS/cm] | | | | | | | | |

### Example 3

### Production of a Membrane by Irradiation

The mixture according to Example 1 is knife-coated at 150° C. onto a carrier of polyethylene terephthalate and a non-self-supporting membrane is obtained. This non-self-supporting membrane is treated by means of electron irradiation at a radiation dose of 33 kGy. The conductivity is measured on the membrane thereby obtained by means of impedance spectroscopy. The mechanical properties (modulus of elasticity, hardness HU and creep Cr) of these irradiated membranes were determined by means of microhardness measurements. The properties of this membrane are summarised in the table and compared with a non-irradiated membrane from Example 2.

### Example 4

Example 3 was basically repeated, except that the treatment was carried out with a radiation dose of 66 kGy. The data obtained are shown in Table 2.

### Example 5

Example 3 was basically repeated, except that the treatment was carried out with a radiation dose of 99 kGy. The data obtained are shown in Table 2.

TABLE 2
Properties of PBI-VPA membranes produced from a PBI-VPA solution

| | Radiation | Conductivity @ | Modulus of | | |
|---|---|---|---|---|---|
| | Dose | 160° C. | Elasticity | HU | |
| Sample | [kGy] | [mS/cm] | [MPa] | [MPa] | Cr [%] |
| Ex. 2 | 0 | 31.8 | 1 | 0.05 | 2 |
| Ex. 3 | 33 | 19.1 | 92 | 1.2 | 7.6 |
| Ex. 4 | 66 | 11.9 | 10.2 | 0.38 | 4.5 |
| Ex. 5 | 99 | 9.5 | 6.2 | 0.27 | 3.9 |

### Example 6

### Production of a PBI-VPA Membrane with Crosslinking Agent

The mixture according to Example 1 is knife-coated at 150° C. onto a carrier of polyethylene terephthalate and a non-self-supporting membrane is obtained. This non-self-supporting membrane is placed for 20 hours at room temperature in a solution consisting of 50 g of vinylphosphonic acid (97%) obtainable from Clariant, and 1.4 g of N,N′-methylenebisacrylamide. The membrane is then treated by means of electron irradiation at a radiation dose of 33 kGy. The conductivity is measured on the membrane thus obtained by means of impedance spectroscopy. The mechanical properties of these irradiated membranes were determined by means of microhardness measurements. The properties of these membranes are summarised in Table 3.

### Example 7

Example 6 was basically repeated, except that the treatment was carried out with a radiation dose of 66 kGy. The data obtained are shown in Table 3.

### Example 8

Example 6 was basically repeated, except that the treatment was carried out with a radiation dose of 99 kGy. The data obtained are shown in Table 3.

TABLE 3
Properties of irradiated PBI-VPA membranes produced from a
PBI-VPA solution

| | Radiation | Conductivity @ | Modulus of | | |
|---|---|---|---|---|---|
| | Dose | 160° C. | Elasticity | HU | |
| Sample | [kGy] | [mS/cm] | [MPa] | [MPa] | Cr [%] |
| Ex. 6 | 33 | 16.6 | 13.4 | 0.4 | 6.1 |
| Ex. 7 | 66 | 10.2 | 10.9 | 0.46 | 5.3 |
| Ex. 8 | 99 | 4.1 | 5.8 | 0.26 | 7.3 |

### Example 9

### Process for the Preparation of a VPA-PBI Solution

100 g of a polybenzimidazole polymer with an intrinsic viscosity of 1.0 dl/g are treated for 4 hours at 160° C. in 250 ml of an 89% phosphoric acid solution. The excess acid is then suction filtered through a filter and washed three times with water. The polymer thus obtained is then neutralised twice with 100 ml of a 10% ammonium hydroxide (NH₄OH) solution and afterwards treated twice with distilled water. The polymer is then treated at 160° C. for 1 hour so that the residual moisture is 8%. 600 g of vinylphosphonic acid (97%) obtainable from Clariant are then added to 65 g of the thus pretreated PBI polymer. A homogeneous solution is formed while gently stirring for 4 hours at 150° C.

### Example 10

A non-self-supporting membrane is knife-coated at 150° C. from this solution from Example 9.

This non-self-supporting membrane is treated by electron irradiation at a radiation dose of 33 kGy. The conductivity is measured on the membrane thereby obtained by means of impedance spectroscopy. The mechanical properties of these irradiated membranes were determined by means of microhardness measurements. The properties of these membranes are summarised in Table 4.

### Example 11

Example 10 was basically repeated, except that the treatment was carried out with a radiation dose of 66 kGy. The data obtained are shown in Table 4.

### Example 12

Example 10 was basically repeated, except that the treatment was carried out with a radiation dose of 99 kGy. The data obtained are shown in Table 4.

### Example 13

Example 10 was basically repeated, except that the treatment was carried out with a radiation dose of 198 kGy. The data obtained are shown in Table 4.

TABLE 4
Properties of irradiated PBI-VPA membranes produced from a
PBI-VPA solution

| | Radia- | | | | | |
|---|---|---|---|---|---|---|
| | tion | Conductivity | Conductivity | Mod. of | | |
| | Dose | @ 80° C. | @ 160° C. | Elast. | HU | Cr |
| Exmpl. | [kGy] | [mS/cm] | [mS/cm] | [MPa] | [MPa] | [%] |
| 10 | 33 | 4.1 | 13.4 | 23 | 1 | 4.4 |
| 11 | 66 | 2.7 | 8.3 | 29 | 1.6 | 4.1 |
| 12 | 99 | 1.6 | 5.7 | 33 | 1.6 | 3.1 |
| 13 | 198 | 0.75 | 0.9 | 193 | 7.4 | 4.1 |

In order to determine the content of acid that can be washed out the irradiated membranes according to Examples 10 to 12 are in a first stage added at room temperature to water, stirred for 10 minutes, and the released acid is calculated, after removal of the membrane, by means of titration from the consumption of 0.1 M sodium hydroxide up to the second titration point. In a second step the membrane sample is treated in a beaker for 30 minutes with boiling water. The acid that is thereby released is again measured by means of titration from the consumption of 0.1 M sodium hydroxide up to the second titration point. In a third step the membrane pretreated in this way is again treated for 30 minutes with boiling water and the acid thereby released is again determined by means of titration. The results obtained are shown in Table 5.

If this procedure is carried out with a non-irradiated membrane, then the consumption of 0.1 M sodium hydroxide up to the second end point in the first step is 54.5 ml, in the second step is less than 2 ml and in the third step is less than 0.2 ml.

TABLE 5
Results of the acid retention measured by means of titration

| | | | V (0.1 M | V (0.1 M | V (0.1 M |
|---|---|---|---|---|---|
| | Irradiation | Thick- | NaOH) | NaOH) | NaOH) |
| | Dose | ness | after 1^{st} step | after 2^{nd} step | after 3^{rd} step |
| Ex | [kGy] | [μm] | [ml] | [ml] | [ml] |
| 10 | 33 | 345 | 44.5 | 0.2 | 0.05 |
| 11 | 66 | 374 | 46 | 0.9 | 0.05 |
| 12 | 99 | 324 | 35.2 | 1.2 | 0.14 |

1-15. (canceled)

16. A proton-conducting polymer membrane based on polyvinylphosphonic acid obtained by a process comprising the steps:
a) mixing a polymer with vinyl-containing phosphonic acid,
b) forming a two-dimensional structure using the mixture of step a) on a carrier, and
c) polymerizing the vinyl-containing phosphonic acid present in the two-dimensional structure of step b), and
characterized in that the membrane has a thickness in the range from 15 μm to 1000 μm.

17. The membrane of claim 16, characterized in that the polymer used in step a) is a high temperature-stable polymer that contains at least one nitrogen, oxygen, or sulfur atom in a repeating unit or in different repeating units.

18. The membrane of claim 16, characterized in that one or more polyazoles or polysulfones are used in step a).

19. The membrane of claim 16, characterized in that the mixture produced in step a) contains compounds of the formula 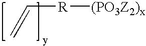
wherein
R denotes a bond, a C1-C15 alkyl group, C1-C15 alkoxy group, ethyleneoxy group or C5-C20 aryl or heteroaryl group, wherein the above radicals are optionally substituted by halogen, —OH, —COOZ, —CN, NZ₂,
Z independently of one another denote hydrogen, a C1-C15 alkyl group, C1-C15 alkoxy group, ethyleneoxy group or C5-C20 aryl or heteroaryl group, wherein the aforementioned radicals are optionally substituted by halogen, —OH, —CN,
x is a whole number 1, 2, 3, 4, 5, 6, 7, 8, 9 or 10, and
y is a whole number 1, 2, 3, 4, 5, 6, 7, 8, 9 or 10, or
the formula 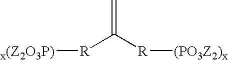
wherein
R denotes a bond, a C1-C15 alkyl group, C1-C15 alkoxy group, ethyleneoxy group or C5-C20 aryl or heteroaryl group, wherein the above radicals are optionally substituted by halogen, —OH, —COOZ, —CN, NZ₂,
Z independently of one another denote hydrogen, a C1-C15 alkyl group, C1-C15 alkoxy group, ethyleneoxy group or C5-C20 aryl or heteroaryl group, wherein the aforementioned radicals are optionally substituted by halogen, —OH, —CN, and
x is a whole number 1, 2, 3, 4, 5, 6, 7, 8, 9 or 10, or
the formula 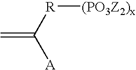
wherein
A represents a group of the formulae COOR², CN, CONR²₂, OR² or R², wherein R² denotes hydrogen, a C1-C15 alkyl group, C1-C15 alkoxy group, ethyleneoxy group or C5-C20 aryl or heteroaryl group, wherein the aforementioned radicals are optionally substituted by halogen, —OH, COOZ, —CN and NZ₂,
R denotes a bond, a double bond C1-C15 alkylene group, C1-C15 alkyleneoxy group, wherein the above radicals are optionally substituted by halogen, —OH, —COOZ, —CN, NZ₂,
Z independently of one another denote hydrogen, a C1-C15 alkyl group, C1-C15 alkoxy group, ethyleneoxy group or C5-C20 aryl or heteroaryl group, wherein the aforementioned radicals are optionally susbstituted by halogen, —OH, —CN, and
x is a whole number 1, 2, 3, 4, 5, 6, 7, 8, 9 or 10.

20. The membrane of claim 16, characterize in that the mixture prepared in step a) contains monomers capable of undergoing crosslinking.

21. The membrane of claim 16, characterized in that the polymerization in step c) is effected by a substance that is capable of forming free radicals.

22. The membrane of claim 16, characterized in that the polymerization in step c) is carried out by irradiation with IR light, NIR light, UV light, β rays, γ rays, or electron beams.

23. The membrane of claim 16, characterized in that the membrane has an intrinsic conductivity of at least 0.001 S/cm.

24. The membrane of claim 16, characterized in that the membrane contains between 0.5 and 97 wt. % of the polymer and between 99.5 and 3 wt. % of polyvinylphosphonic acid.

25. The membrane of claim 16, characterized in that the membrane comprises a layer containing a catalytically active component.

26. A mixture containing:
a vinyl-containing phosphonic acid having the formula 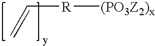
wherein
R denotes a bond, a C1-C15 alkyl group, C1-C15 alkoxy group, ethyleneoxy group or C5-C20 aryl or heteroaryl group, wherein the above radicals are optionally substituted by halogen, —OH, —COOZ, —CN, NZ₂,
Z independently of one another denote hydrogen, a C1-C15 alkyl group, C1-C15 alkoxy group, ethyleneoxy group or C5-C20 aryl or heteroaryl group, wherein the aforementioned radicals are optionally substituted by halogen, —OH, —CN,
x is a whole number 1, 2, 3, 4, 5, 6, 7, 8, 9 or 10, and
y is a whole number 1, 2, 3, 4, 5, 6, 7, 8, 9 or 10, or
the formula 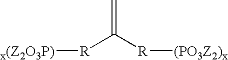
wherein
R denotes a bond, a C1-C15 alkyl group, C1-C15 alkoxy group, ethyleneoxy group or C5-C20 aryl or heteroaryl group, wherein the above radicals are optionally substituted by halogen, —OH, —COOZ, —CN, NZ₂,
Z independently of one another denote hydrogen, a C1-C15 alkyl group, C1-C15 alkoxy group, ethyleneoxy group or C5-C20 aryl or heteroaryl group, wherein the aforementioned radicals are optionally substituted by halogen, —OH, —CN, and
x is a whole number 1, 2, 3, 4, 5, 6, 7, 8, 9 or 10, or
the formula 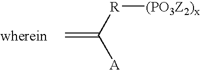
A represents a group of the formulae COOR², CN, CONR²₂, OR² or R², wherein R² denotes hydrogen, a C1-C15 alkyl group, C1-C15 alkoxy group, ethyleneoxy group or C5-C20 aryl or heteroaryl group, wherein the aforementioned radicals are optionally substituted by halogen, —OH, COOZ, —CN and NZ₂,
R denotes a bond, a double bond C1-C15 alkylene group, C1-C15 alkyleneoxy group, wherein the above radicals are optionally substituted by halogen, —OH, —COOZ, —CN, NZ₂,
Z independently of one another denote hydrogen, a C1-C15 alkyl group, C1-C15 alkoxy group, ethyleneoxy group or C5-C20 aryl or heteroaryl group, wherein the aforementioned radicals are optionally susbstituted by halogen, —OH, —CN, and
x is a whole number 1, 2, 3, 4, 5, 6, 7, 8, 9 or 10; and
at least one polymer that has a solubility of at least 1 wt. % at a temperature of 160° C. and 1 bar in the vinyl-containing phosphonic acid, characterized in that the polymer is selected from polyazoles or polysulfones.

27. The mixture of claim 26, characterized in that the mixture contains at least one monomer capable of undergoing crosslinking.

28. The mixture of claim 26, characterized in that the mixture contains at least one starter that is capable of forming free radicals.

29. A membrane-electrode unit containing at least one proton-conducting polymer membrane based on polyvinylphosphonic acid obtained by a process comprising the steps:
a) mixing a polymer with vinyl-containing phosphonic acid,
b) forming a two-dimensional structure using the mixture of step a) on a carrier, and
c) polymerizing the vinyl-containing phosphonic acid present in the two-dimensional structure of step b), and
characterized in that the membrane has a thickness in the range from 15 μm to 1000 μm.

30. The unit of claim 29, characterized in that one or more polyazoles or polysulfones are used in step a).

31. The unit of claim 29, characterized in that the mixture produced in step a) contains compounds of the formula 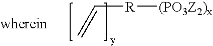
R denotes a bond, a C1-C15 alkyl group, C1-C15 alkoxy group, ethyleneoxy group or C5-C20 aryl or heteroaryl group, wherein the above radicals are optionally substituted by halogen, —OH, —COOZ, —CN, NZ₂,
Z independently of one another denote hydrogen, a C1-C15 alkyl group, C1-C15 alkoxy group, ethyleneoxy group or C5-C20 aryl or heteroaryl group, wherein the aforementioned radicals are optionally substituted by halogen, —OH, —CN,
x is a whole number 1, 2, 3, 4, 5, 6, 7, 8, 9 or 10, and
y is a whole number 1, 2, 3, 4, 5, 6, 7, 8, 9 or 10, or
the formula 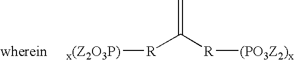
R denotes a bond, a C1-C15 alkyl group, C1-C15 alkoxy group, ethyleneoxy group or C5-C20 aryl or heteroaryl group, wherein the above radicals are optionally substituted by halogen, —OH, —COOZ, —CN, NZ₂,
Z independently of one another denote hydrogen, a C1-C15 alkyl group, C1-C15 alkoxy group, ethyleneoxy group or C5-C20 aryl or heteroaryl group, wherein the aforementioned radicals are optionally substituted by halogen, —OH, —CN, and
x is a whole number 1, 2, 3, 4, 5, 6, 7, 8, 9 or 10, or
the formula 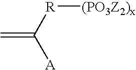
wherein
A represents a group of the formulae COOR², CN, CONR²₂, OR² or R², wherein R² denotes hydrogen, a C1-C15 alkyl group, C1-C15 alkoxy group, ethyleneoxy group or C5-C20 aryl or heteroaryl group, wherein the aforementioned radicals are optionally substituted by halogen, —OH, COOZ, —CN and NZ₂,
R denotes a bond, a double bond C1-C15 alkylene group, C1-C15 alkyleneoxy group, wherein the above radicals are optionally substituted by halogen, —OH, —COOZ, —CN, NZ₂,
Z independently of one another denote hydrogen, a C1-C15 alkyl group, C1-C15 alkoxy group, ethyleneoxy group or C5-C20 aryl or heteroaryl group, wherein the aforementioned radicals are optionally susbstituted by halogen, —OH, —CN, and
x is a whole number 1, 2, 3, 4, 5, 6, 7, 8, 9 or 10.

32. The unit of claim 30, characterized in that the membrane has an intrinsic conductivity of at least 0.001 S/cm.

33. The unit of claim 30, characterized in that the membrane contains between 0.5 and 97 wt. % of the polymer and between 99.5 and 3 wt. % of polyvinylphosphonic acid.

34. The unit of claim 30, characterized in that the membrane comprises a layer containing a catalytically active component.

35. A fuel cell containing:
one or more proton-conducting polymer membranes based on polyvinylphosphonic acid obtained by a process comprising the steps:
a) mixing a polymer with vinyl-containing phosphonic acid;
b) forming a two-dimensional structure using the mixture of step a) on a carrier; and
c) polymerizing the vinyl-containing phosphonic acid present in the two-dimensional structure of step b); and
characterized in that the membrane has a thickness in the range from 15 μm to 1000 μm; or
one or more membrane-electrode units containing at least one of the proton-conducting polymer membranes.
